(19) United States
(12) Patent Application Publication
(10) Pub. No.: US 2008/0239404 A1
(43) Pub. Date: Oct. 2, 2008

(54) IMAGE FORMING APPARATUS AND IMAGE FORMING METHOD

(75) Inventors: Takehiko Kawasaki, Kamakura-shi (JP); Norio Kaneko, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/050,145

(22) Filed: Mar. 17, 2008

(30) Foreign Application Priority Data
Mar. 30, 2007 (JP) 2007-092030

(51) Int. Cl. H04N 1/40

(52) U.S. Cl. 358/3.28

(57) ABSTRACT

A method and apparatus are provided for forming an image on a surface of medium having variable surface attributes affecting image formation. The image forming apparatus includes an image forming unit configured to form images on a surface on which images are to be formed, including a plurality of areas with different attributes, in a medium for forming images, on the basis of input image information, and a determination unit configured to determine, for the plurality of areas, conditions for forming images or positions in which images are formed. The image forming unit forms images on the basis of conditions for forming images or positions in which images are formed determined by the determination unit.

### BACKGROUND OF THE INVENTION

1. Field of the Invention

The present invention relates to an image forming apparatus that performs processes, such as image formation, on media for forming images, such as sheet material.

2. Description of the Related Art

Recently, in image forming apparatuses (for example, laser beam printers (LBPs), copying machines, and inkjet printers), the demand for high image quality and high-speed processing has increased. On the other hand, the type of media for forming images (that may hereinafter simply be described as media), such as paper to be used, varies with, for example, users who use apparatuses or the operating environment. Image forming apparatuses need to support these media.

These days, media for recording images that have uneven structures on the surfaces on which images are to be formed are available. For example, a sheet in which an element, such as a type of integrated circuit (IC) tag (hereinafter described as an RFID), is embedded is available. In this case, a semiconductor element formed of, for example, silicon is embedded in paper. The practical use of the sheet as a sheet for conveying information of an individual object, such as a ticket or food, has been started. Another example is embossed paper the touch of which is improved by providing undulations on surfaces thereof. Other examples are craft paper in which, for example, pressed flowers or leaves are mixed or put and craft paper in which watermarks are formed. Yet another example is paper that is folded so as to achieve cushioning for packaging. In media other than those in which uneven structures are intentionally given, as described above, histories (for example, influence of moisture) may be different within surfaces on which images are to be formed. In such media, characteristics (that are hereinafter generically described as attributes and are described below in detail) including mechanical properties and optical properties vary with areas on surfaces in a manner that depends on, for example, the structures and histories of the areas.

Japanese Patent Laid-Open No. 2004-38983 discloses that the attributes of a print medium are determined, and the operational settings of a printer are adjusted on the basis of the determined attributes.

Moreover, Japanese Patent Laid-Open No. 2004-276515 discloses a technique for detecting a tag attached to a sheet and prohibiting printing when no tag is detected or when tag information cannot be read even though a tag is detected. Moreover, Japanese Patent Laid-Open No. 2004-284250 discloses a technique for detecting a radiofrequency identification (RFID) tag attached to a sheet, determining the state of loading of the sheet (for example, the top and bottom of the sheet), and performing printing after changing, for example, the top and bottom of an image in response to the determined state of loading of the sheet.

However, in the known art, a case where the attributes of a medium vary with a plurality of individual areas on a surface on which images are to be formed is not supported. For example, such a case includes a case where an area with an attribute that is different from those of other areas exists in a medium, specifically, a case where an RFID tag is embedded in an area on a printing surface that is a surface on which images are to be formed or a case where an area on a printing surface is embossed. In a case where an area with an attribute that is different from those of other areas exists in a medium, in such an area, conditions for forming images may be far from the optimum values, and defects in, for example, image formation may occur, so that, for example, characters and images may blur, and in the worst case, recorded information may become illegible.

### SUMMARY OF THE INVENTION

Thus, the present invention provides an image forming apparatus and an image forming method, in which, even for a medium for forming images that includes a plurality of areas with different attributes on a surface on which images are to be formed, defects in images can be reduced, and high-definition images can be formed.

The present invention provides an image forming apparatus that includes an image forming unit configured to form images on a surface on which images are to be formed, including a plurality of areas with different attributes, in a medium for forming images, on the basis of input image information, and a determination unit configured to determine, for the plurality of areas, conditions for forming images or positions in which images are formed. The image forming unit forms images on the basis of conditions for forming images or positions in which images are formed determined by the determination unit.

Moreover, the present invention provides an image forming method that includes forming images on a surface on which images are to be formed, including a plurality of areas with different attributes, in a medium for forming images, on the basis of input image information, determining, for the plurality of areas, conditions for forming images or positions in which images are formed, and forming images on the basis of determined conditions for forming images or positions in which images are formed.

In the present invention, even for a medium for forming images, the attribute of which varies with areas on the surface on which images are to be formed, defects in images can be reduced, and high-definition images can be formed.

Further features of the present invention will become apparent from the following description of exemplary embodiments (with reference to the attached drawings).

### BRIEF DESCRIPTION OF THE DRAWINGS

FIG. 1 is a block flow diagram showing the operation of an image forming apparatus according to an exemplary embodiment of the present invention.

FIG. 2 shows a unit for detecting attribute information of a surface of a medium according to an exemplary embodiment of the present invention.

FIG. 3 shows a unit for detecting attribute information of a surface of a medium according to an exemplary embodiment of the present invention.

FIG. 4 shows a unit for detecting attribute information of a surface of a medium according to an exemplary embodiment of the present invention.

FIG. 5 shows exemplary determination of addresses on a surface of a medium according to an exemplary embodiment of the present invention.

FIG. 6 shows exemplary determination of addresses on a surface of a medium according to an exemplary embodiment of the present invention.

FIG. 7 shows exemplary determination of addresses on a surface of a medium according to an exemplary embodiment of the present invention.

FIG. 8 shows exemplary determination of addresses on a surface of a medium according to an exemplary embodiment of the present invention.

FIG. 9 shows exemplary determination of addresses on a surface of a medium according to an exemplary embodiment of the present invention.

FIG. 10 shows exemplary determination of addresses on a surface of a medium according to an exemplary embodiment of the present invention.

FIG. 11 shows exemplary determination of addresses on a surface of a medium according to an exemplary embodiment of the present invention.

FIGS. 12A and 12B show exemplary control of positions in which images are formed according to an exemplary embodiment of the present invention.

FIG. 13 shows an exemplary process for controlling positions in which images are formed according to an exemplary embodiment of the present invention.

FIG. 14 shows exemplary control of conditions for forming images according to an exemplary embodiment of the present invention.

FIG. 15 is a block diagram of an image forming apparatus according to an exemplary embodiment of the present invention.

FIG. 16 shows a unit for detecting attribute information of a surface of a medium according to an exemplary embodiment of the present invention.

FIG. 17 shows a unit for detecting attribute information of a surface of a medium according to an exemplary embodiment of the present invention.

FIG. 18 shows exemplary control of conditions for forming images according to an exemplary embodiment of the present invention.

### DESCRIPTION OF THE EMBODIMENTS

A medium for forming images used in the present invention means a recording medium that is an object, in an image forming apparatus, in which images are to be formed. Images are formed mainly in sheet-shaped media for recording images, such as paper (for example, plain paper, glossy paper, coated paper, and recycled paper), a film of, for example, resin, and an overhead transparency (OHT) sheet. Any form of medium for forming images may be adopted, for example, a medium cut into predetermined dimensions (a cut sheet) and a medium wound up into a roll (a roll of paper). Moreover, a medium for forming images may be a single sheet or more than one sheet that overlaps or is bonded together. Moreover, a medium for forming images may be a three-dimensional object formed into a predetermined shape or an object that can be deformed.

The attributes of a medium for forming images in the present invention include at least one of various types of information that influences formation of images on a surface on which images are to be formed. Especially important information is information related to the physical properties and shapes of areas thereof. Examples of such information include the thickness, density, elastic modulus, viscosity, vibration characteristics, texture, surface roughness, deformation, and strength of a medium. The examples further include elastic deformability and/or plastic deformability, the amount of elongation, a color, change in a color, reflectivity, and deformation (elongation, flexing, crushing, rupture, and bending). The examples further include transmittance, the state of curling, gas and liquid permeability, and thermophysical properties, such as thermal diffusivity and heat capacity. Moreover, in the case of paper, the examples include information related to fabrics, filler, and unevenness in a coating layer. Moreover, a water content significantly influences the physical properties, shape, and the like of a medium, and thus is an especially important attribute.

Another important one of the attributes of a medium for forming images is the information of an embedded object that influences the aforementioned physical properties. Exemplary embedded objects include an identification element, such as an identification (ID) tag, and a natural object, such as a pressed flower and a leaf. Other important attributes of a medium for forming images include the information of images that have already been formed, adhesion of a foreign substance, a stain, the size and shape of a medium, the state of bending of, for example, edges, the state of machining, such as cutting or drilling, and adhesion of, for example, a laminate, a coating, and a staple. Moreover, information on whether any area in which a plurality of media are bonded together exists in a surface on which images are to be formed and information on whether a plurality of sheet-shaped objects overlap each other in all or a part of a surface on which images are to be formed are also important information.

A medium for forming images used in the present invention includes a plurality of areas (at least two areas) with different attributes on a surface on which images are to be formed. For example, in the case of a medium that includes an identification element, such as an RFID, a part of a surface on which images are to be formed, including the identification element, is an area with a first attribute, and the remainder of the surface, on which images are to be formed, not including the identification element, is an area with a second attribute. Moreover, in a case where a part of a surface on which images are to be formed is coated, the coated part is an area with a first attribute, and the remainder is an area with a second attribute.

A process of forming images in the present invention means recording, for example, characters, codes, and images on media. In the process of forming images, visible images and invisible images may be formed. A specific process of forming images is printing by, for example, electrophotography, inkjet printing, thermal transfer, or sublimation. Thus, an image forming engine, such as a toner-image transfer unit in an electrophotographic apparatus or an inkjet head in an inkjet apparatus, is an image forming unit. The process of forming images may include corresponding steps, such as correcting the curling of media, stacking media, and sorting, punching, and stapling media for bookbinding.

In the present invention, images are formed in manners suitable for respective areas with different attributes in a medium for forming images. Specifically, images are formed on a surface on which images are to be formed, including a plurality of areas with different attributes, in a medium for forming images, on the basis of input image information.

A determination unit used in the present invention may determine, for a plurality of individual areas with different attributes, conditions for forming images and/or positions in which images are formed. For example, the determination unit includes an electronic circuit, such as a central processing unit (CPU) or a controller.

In the present invention, an address setting unit that sets addresses on a surface on which images are to be formed and an attribute-information detecting unit that detects attribute information that indicates the attributes of a plurality of areas may be provided, and conditions for forming images or positions in which images are formed may be determined on the basis of the addresses set by the address setting unit and the attribute information detected by the attribute-information detecting unit.

The attribute-information detecting unit used in the present invention may include an external-force applying unit that applies an external force to a medium for forming images, an external-force detecting unit that detects, via a medium, an external force applied by the external-force applying unit, and an attribute-information obtaining unit that obtains attribute information on the basis of the result of detection by the external-force detecting unit.

An image forming unit used in the present invention may form images on the basis of conditions for forming images or positions in which images are formed determined by the determination unit. Specifically, the image forming unit is the aforementioned image forming engine.

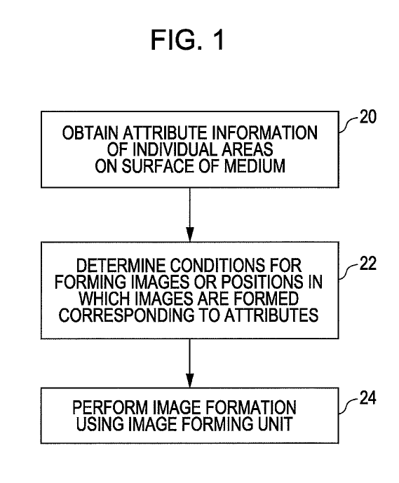

Image forming apparatuses and image forming methods according to exemplary embodiments of the present invention will now be described with reference to FIGS. 1 to 18.

FIG. 1 is a block flow diagram of an image forming apparatus according to an exemplary embodiment of the present invention. The image forming apparatus has at least the following functions, as shown in FIG. 1:

(1) obtaining the attribute information of individual areas on a surface, of a medium for forming images, on which images are to be formed (20),

(2) determining conditions for forming images or positions in which images are formed, for the individual areas, corresponding to the attribute information (22), and

(3) forming images with conditions for forming images or in positions in which images are formed that are determined, using an image forming unit (24).

Each of the functions will now be described in more detail.

### Obtaining Attribute Information of Individual Areas on a Surface of a Medium

Attribute information is obtained in the following ways.

Obtaining Attribute Information Using Attribute-Information Detecting Unit that Detects Attribute Information of Surface of Medium

Attribute information may be obtained using a unit that at least has resolutions corresponding to individual areas of a medium and detects the attribute information of a surface of the medium.

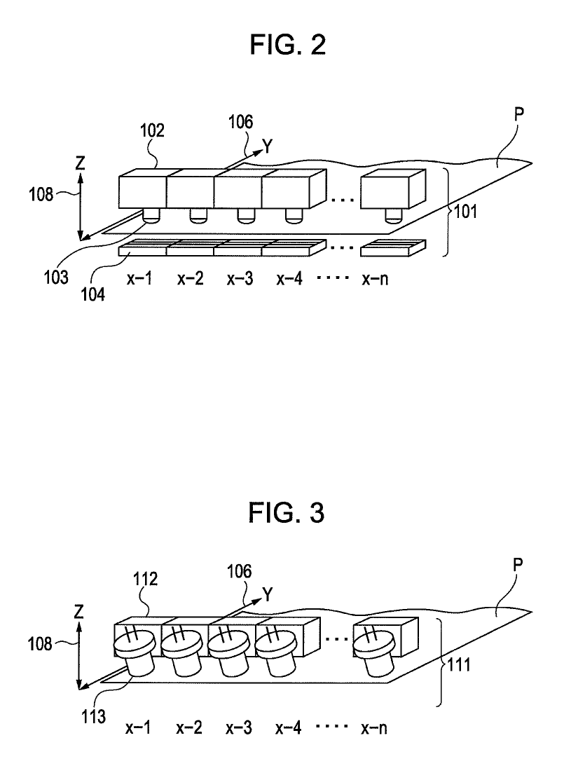

Referring now to FIG. 2, a medium sensor array 101 (described in the exemplary embodiments in more detail) may be used. In the medium sensor array, sensors that can detect the mechanical properties of a medium P are arranged in an array at positions x-1 to x-n. An example of a sensor that can detect the mechanical properties of a medium P shown in FIG. 2 is a sensor that applies an impact force to a medium using an external-force applying unit, such as an external-force applying unit 102 and an external-force applying member 103, and detects a reaction from the medium using pressure-sensitive elements, such as an external-force detecting unit 104. In this arrangement, for example, local flexural rigidity and compressive rigidity of a medium are detected, and the mechanical properties are detected as attribute information of the individual areas. Another example sensor is a sensor that transmits vibrations to a medium and detects a reaction from the medium using pressure-sensitive elements. In other examples, a surface of a medium may be rubbed with a probe to detect, for example, the texture or friction of the surface, and, for example, reflections or transmission characteristics in response to transmitting waves, for example, acoustic waves, may be detected.

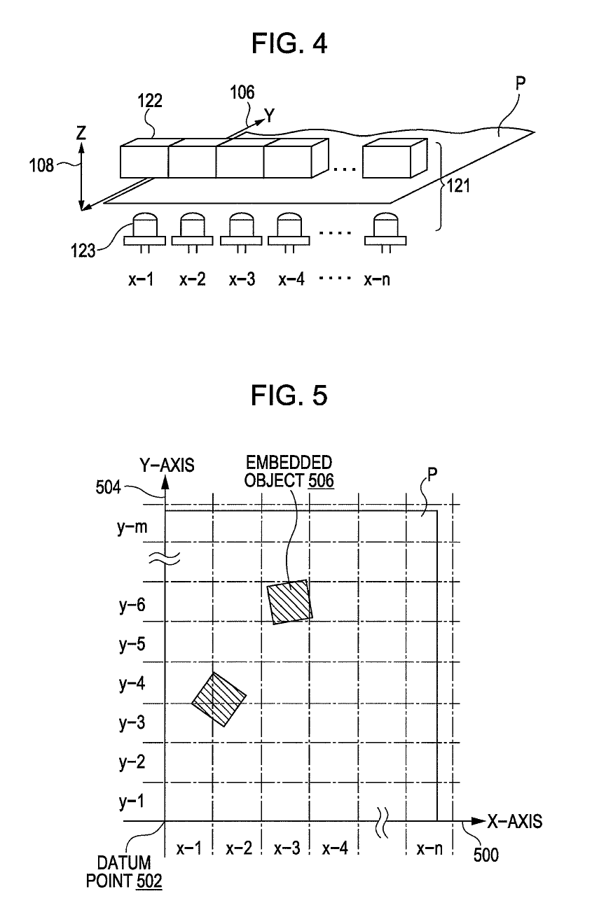

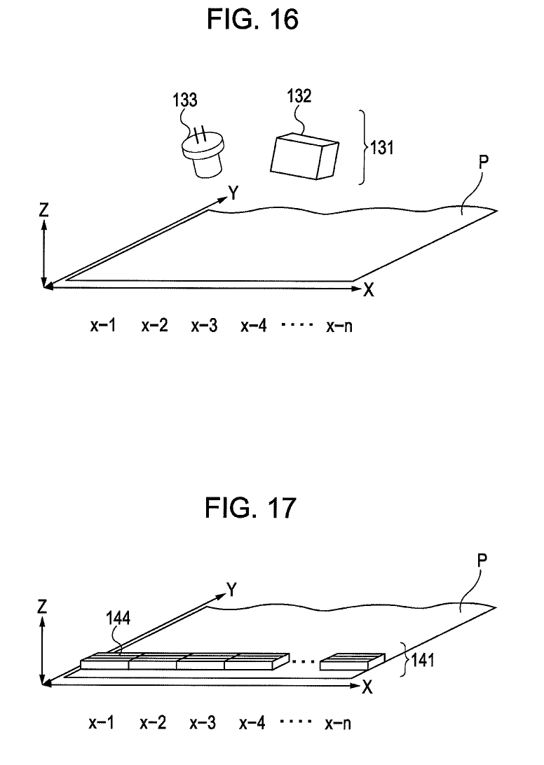

Another exemplary method for detecting attribute information is a method for detecting a reaction in response to, for example, light or electromagnetic waves from a medium. FIG. 3 shows an exemplary reflective detection system for detecting a reaction from medium P. In FIG. 3, reference numerals 111, 112, and 113 denote a reflective detection system, photo detectors, and light sources, respectively. The photo detectors and light sources are arrayed across medium P at positions x-1 to x-n. FIG. 4 shows an exemplary transmissive detection system for a medium P. In FIG. 4, reference numerals 121, 122, and 123 denote a transmissive detection system, photo detectors, and light sources, respectively. The photo detectors and light sources are arrayed across medium P at positions x-1 to x-n. Alternatively, a single photo detector may be used, as shown in FIG. 16. The frequency band, waveform, intensity, and the like of, for example, light or electromagnetic waves are appropriately selected to meet the need. When visible light is used, for example, the glossiness and transparency that can be recognized by humans can be detected. When a frequency band (for example, some infrared rays, microwaves, and terahertz waves) highly sensitive to water is used, the water content can be detected. When a frequency band (for example, some beta rays) highly sensitive to the constituents of a medium, for example, cellulose, is used, for example, the basis weight or the thickness of paper can be detected. In these examples, positions relative to a medium may be scanned to meet the need. Moreover, a large number of photo detectors and light sources may be arranged in two dimensions. When these systems are used, the analysis may be performed automatically or by a human who operates the systems.

In a case where a medium bears any marking (including a receiver that reads, for example, the position of an RFID), the attribute information may be detected from the marking information.

A unit that can detect the mechanical properties of a medium may be used as the aforementioned unit, which is used in the present invention and detects the attribute information of a surface of a medium. This is because the mechanical properties of a medium, physical properties that can be estimated from the mechanical properties, and the like are important in image formation. FIG. 2 shows an example of such a unit. At least an external-force applying unit that applies an external force to a medium P and an external-force detecting unit that detects, via the medium P, the external force applied by the external-force applying unit need to be provided. In this case, the exemplary unit includes an external-force detecting unit that detects an external force applied by an external-force applying unit from the back side of the medium P, the medium P being sandwiched between the external-force detecting unit and the external-force applying unit, and the information of the medium P is obtained on the basis of the result of detection by the external-force detecting unit. Signals from the unit, which detects the attributes of a surface of a medium, are obtained as, for example, voltage waveforms. In the unit, which is used in the present invention and detects the attributes of a surface of a medium, when general information, such as basis weight and thickness, can be obtained in advance from, for example, the manufacturer or type number of a sheet, conditions for detection may be correspondingly and appropriately adjusted. For example, in the case of paper that has a large basis weight, the value of an external force to be applied may be increased. In FIG. 2, the components of such a unit are arranged in a plurality of parallel arrays.

Other than the aforementioned unit, a unit that detects the humidity in the neighborhood of a medium or a unit that detects the resistance or capacity as an electrical property may be used as the unit, which detects the attributes of a surface of a medium.

Such units may be used in combination.

Obtaining Attribute Information from Input of Information of a Medium

When the information of a medium corresponding to individual areas in the medium is known, the attribute information is obtained from input of this information. This is applicable, for example, when a predetermined pattern is printed on a sheet or when the structure (for example, the texture) of a medium is known. The information may be input manually, or automatically by reading, for example, a bar code or two-dimensional code on a medium or a package.

Addresses may be assigned to individual areas in such a medium. In this arrangement, the correspondence between image information input to an image forming apparatus and the attribute information of individual areas in a medium can be readily determined. Moreover, the image forming unit can readily determine the positions of images relative to a medium.

The following unit is used in the present invention as the address setting unit.

FIGS. 5 to 11 illustrate the operation of exemplary address setting units. In general, a datum point is first determined. Then, addresses corresponding to areas are determined. Any method corresponding to an applicable image forming apparatus may be used as a method for determining addresses, including the following exemplary methods.

Grid with x-Axis and y-Axis

Referring now to FIG. 5, the shorter side of a cut sheet is taken as an x-axis 500, the left end of the shorter side is taken as the origin point, i.e., the datum point 502, and the y-axis 504 orthogonal to the shorter side is determined (since, in general, a cut sheet is precisely cut into a rectangle, the longer side on the left side of the drawing corresponds to the y-axis). Addresses corresponding to the x-axis, such as x-1 to x-n, and the y-axis, such as y-1 to y-n, are set on a grid. The datum point is not limited to the aforementioned example and may be selected in any way. Such a method is effective especially when the distribution of attributes of a medium is almost random. For example, the method is effective for paper in a predetermined position at which an embedded object 506, for example, an RFID or a leaf is embedded, and a sheet on which irregular undulations are formed. The method is also effective when the information of a medium is unavailable or poor.

Distances from Datum

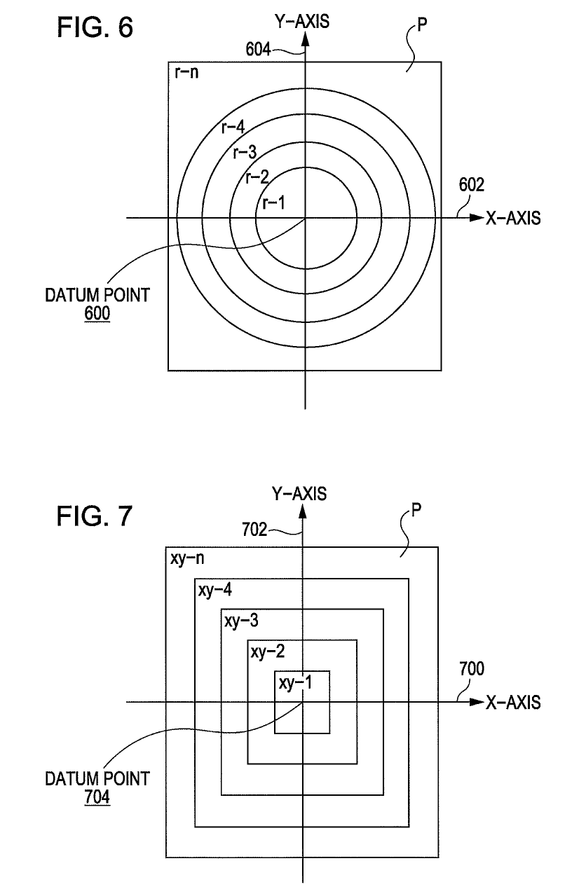

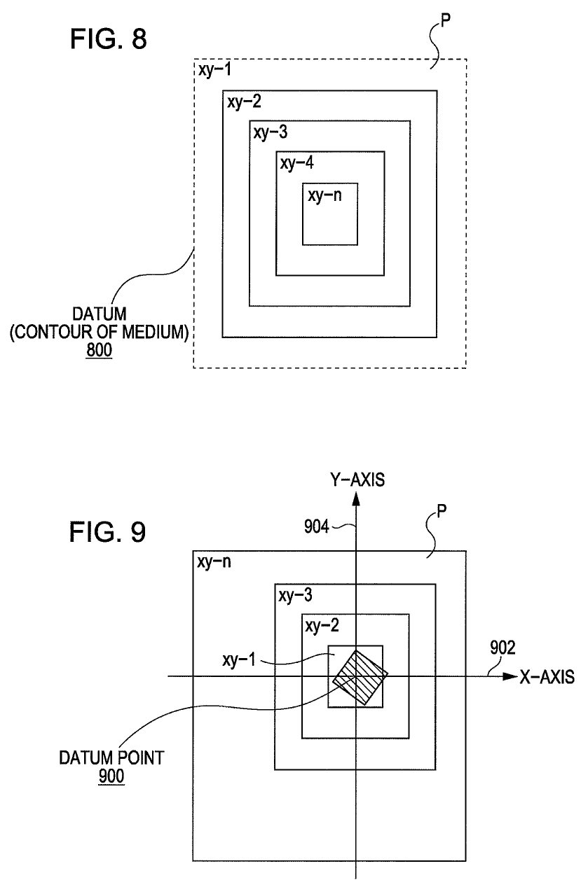

Referring now to FIG. 6, the center of a medium P may be taken as the datum point 600, and addresses may be determined by distances (r-1 to r-n) from the datum point 600 along an x-axis 602 and a y-axis 604. Referring now to FIG. 7, alternatively, the x-axis 700 and the y-axis 702 parallel to the shorter side and the longer side respectively may be set so as to extend from a similar datum point 704, and a rectangular areas xy-1 to xy-n that cover a predetermined range of values of x and a predetermined range of values of y, x and y indicating distances from the datum point, may be determined as an address. Referring now to FIG. 8, alternatively still, the contour 800 of a medium P may be set as the datum, and addresses xy-1 to xy-n may be determined by distances from the datum 800. Such a method is effective when the attribute changes along a direction from the center of a medium to the contour, for example, when stacked cut sheets take up moisture at the outer edges thereof and become deteriorated. Referring now to FIG. 9, alternatively still, for example, when a specific structure (for example, an embedded object such as an RFID, undulations, or a marker) exists in a medium, the position information of the structure may be obtained as the datum point 900, and addresses xy-1 to xy-n for a medium P along an x-axis 902 and a y-axis 904 may be determined by distances from the datum point 900.

Intervals from Datum Point

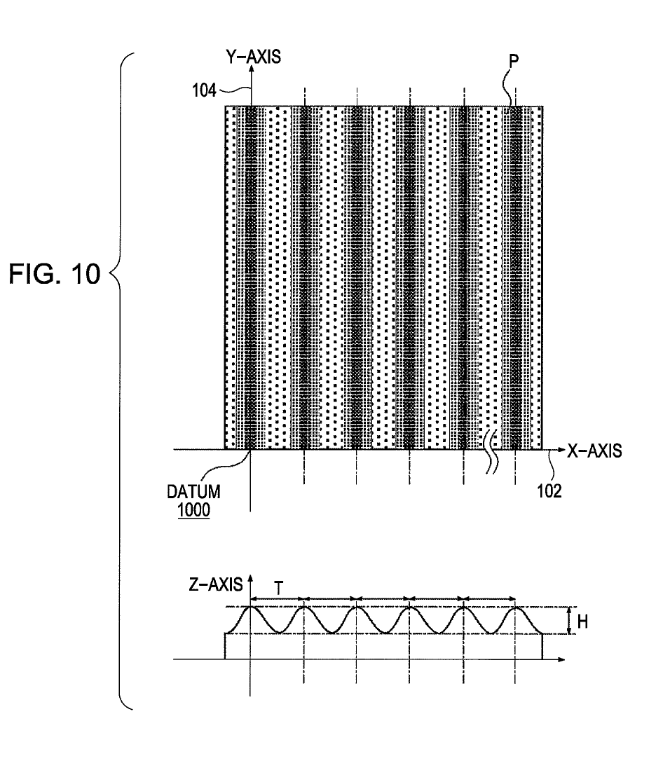

Referring now to FIG. 10, when a medium P includes an ordered structure, for example, an end of the medium or a specific structure may be set as the datum point 1000, and addresses and attributes for areas along an x-axis 102 and an y-axis 104 may be defined on the basis of information, such as the interval between undulations or the amplitude of undulations. Such a method is effective, for example, for paper that is made so as to include undulations in a striped pattern. FIG. 10 shows a top view and a sectional view, taken along a line parallel to the x-axis, of exemplary paper that includes undulations parallel to the y-axis. In this example, the straight edge line of the leftmost undulation is set as the datum 1000, and undulations are provided at regular intervals denoted by T, the height of the undulations being indicated by H. In this case, starting from the datum, conditions for forming images are changed to values corresponding to the height H at the intervals T.

### Specific Part and the Like

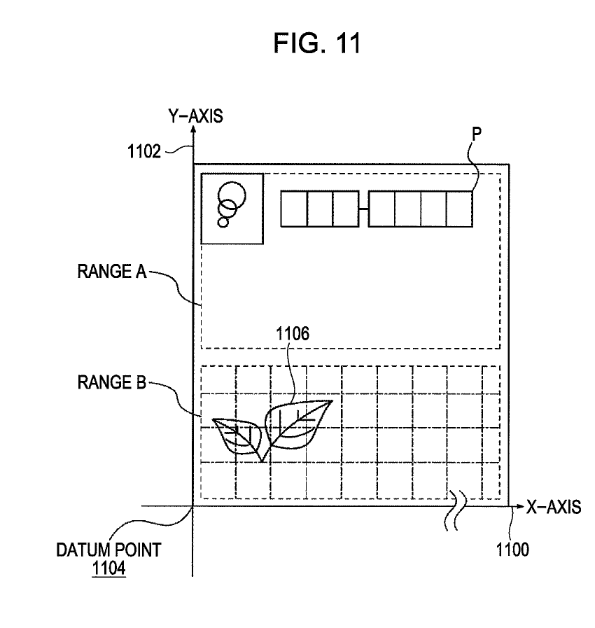

Referring now to FIG. 11, when the attributes of individual areas in a medium are different according to predetermined rules, each of the areas may be set as an address; and furthermore, each of the areas may be divided into sub-areas, and addresses may be assigned to the sub-areas, as necessary. Such a method is effective for a medium which is in a predetermined format but a part of which varies individually. For example, the method is effective for a postcard on which postcode columns are formed in a predetermined area, and, for example, an illustration is formed on a user-selected area. FIG. 11 shows an exemplary postcard medium P on which postcode columns are formed in a predetermined position in a range A, and a natural object 1106 is embedded in a user-selected position in a range B. In the range A, since columns and the like are disposed according to predetermined rules, image formation is performed using the corresponding position information as known attribute information. In the range B, addresses on a grid with the x-axis 1100 and the y-axis 1102 having an intersection at a datum point 1104 are assigned, as in the example in FIG. 5, and attribute information is detected separately for each of the addresses.

When at least two addresses as described above exist on a surface of a medium, advantages of the present invention can be achieved. Moreover, more detailed addresses may be needed. In current high-definition image forming apparatuses, a corresponding area may need to be divided into sub-areas to which respective addresses are assigned, each of the sub-areas measuring about 5 μm per side. Addresses can be set in a manner that depends on the purpose.

The aforementioned addresses may change due to deformation, such as expansion and contraction, of a medium. In this case, the addresses are used after appropriate correction. For example, paper may shrink in the longitudinal and transverse directions by respective different percentages by evaporation of moisture by heating. In such a case, changes in the longitudinal and transverse dimensions are measured to perform correction corresponding to the degree of shrinkage.

While paper cut into a rectangle of predetermined dimensions (what is called a cut sheet) has been described as an exemplary medium, the medium is not limited to this paper. Main media supported in the present invention are sheet-shaped media for recording images, such as paper, a film of, for example, resin, and an OHT sheet. However, the media supported in the present invention are not limited to those described above, and all media, including a medium that is a three-dimensional object formed into a predetermined shape and a medium that can be deformed, are supported as long as images can be formed and the datum point and coordinates for determining addresses can be determined in the media.

Determining Conditions for Forming Images or Positions in which Images are Formed Corresponding to Attributes

In the present invention, for individual areas on a surface, of a medium, on which images are to be formed, image formation suitable for the attributes of the individual areas is performed. Thus, conditions for forming images or positions in which images are formed corresponding to the attributes of the individual areas are determined. Conditions for forming images may be determined or controlled so as to be specific conditions, and/or positions in which images are formed may be determined or controlled so as to be specific positions. Examples of conditions for forming images and positions in which images are formed will now be described.

Control of Positions in which Images are Formed

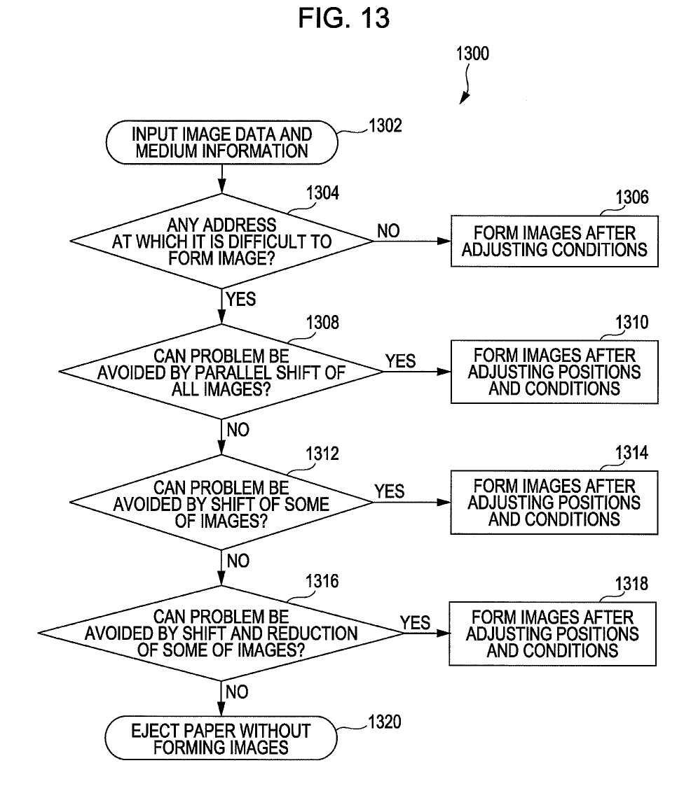

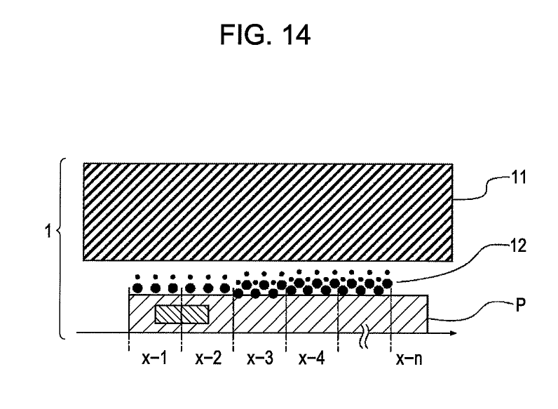

An exemplary method of controlling positions is one in which, when it is determined that the attribute of a certain area causes difficulty or a trouble in image formation, adjustment is performed so that images are formed in appropriate shapes in appropriate positions, avoiding the area. For example, when a solid-state semiconductor element, such as an RFID that functions as an identification element, is embedded in an area of a medium, in the area, the property of the medium is different from those of the other areas. For example, in such an area, an effective thickness of paper (thickness that contains ingredients of paper, such as cellulose) may be significantly small, and the rigidity, durability, and color may be different from those of a surrounding area. When an image is formed on such an area with the same conditions as the surrounding area, the image (including character information) may look patchy, or a malfunction in an element may occur. Thus, images are formed on areas other than such an area by changing, for example, the positions and sizes of the images by an algorithm in which the balance among all the images is considered (FIG. 13).

Such a method is effective especially when, for example, the date and time and place of a performance, a seat type, a seat number, and a notice that are information that need to be reliably recognized visually by humans need to be printed on, for example, a ticket of thin paper in which an RFID is embedded without defect. Similarly, the method is also effective when character information needs to be printed in an appropriate position on paper in which a natural object that has no definite shape, such as a freehand drawing or a leaf, is embedded, or when, for example, a picture and characters need to be printed in appropriate positions relative to frame lines.

### Control of Conditions for Forming Images

When appropriate conditions for forming images vary with the individual areas of a medium, the conditions for forming images are adjusted so as to fall in respective appropriate ranges. Especially important conditions for forming images are conditions for transferring coloring material, including toner for electrophotography and ink for inkjet printers, to a medium. Specifically, conditions for forming images are adjusted by changing conditions for forming images so as to fit individual areas or changing conditions for controlling image formation so as to form clear images the balance among which is achieved.

An example of such adjustment includes forming images on an area with a small effective thickness of paper, i.e., an area with an attribute (information) that indicates that the thickness is small, in a mode suitable for thin paper. For example, the amount of coloring material to be transferred is decreased. On the other hand, images are formed on an area with a large effective thickness, i.e., an area with an attribute (information) that indicates that the thickness is large, in a mode suitable for thick paper. For example, the amount of coloring material to be transferred is increased. In this way, for areas with different attributes on a surface on which images are to be formed, image formation is performed with conditions for forming images that are determined corresponding to the attribute information of the areas.

First of all, conditions for forming images related to adjustment of the amount of coloring material to be transferred should be controlled. For example, the amount of toner to be supplied to or the amount of ink to be deposited on a medium is adjusted. In the next place, conditions for fixing coloring material should be adjusted. For example, a fixing temperature and a fixing pressure are adjusted.

Adjusting conditions for forming images in a manner that depends on the obtained attributes of individual areas is not limited to adjusting the positions of images and adjusting conditions for transferring coloring material, described above.

Determination of conditions for forming images and positions in which images are formed, described above, is performed by a processor that processes image data input to an image forming apparatus to determine the operation of an image forming unit. The processor may be provided in the image forming apparatus, or such a function may be delegated to, for example, an external computer.

### Forming Images Using Image Forming Unit

Images are formed on a medium with conditions for forming images determined as described above.

### First Exemplary Embodiment

An image forming apparatus according to a first exemplary embodiment of the present invention will now be described.

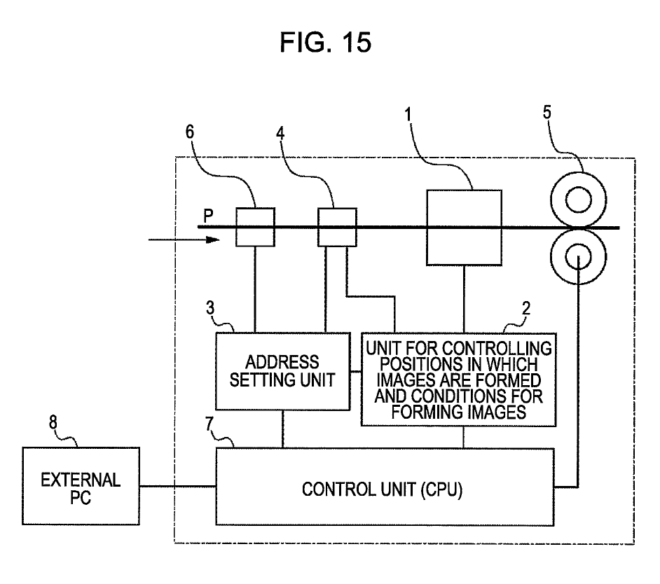

Referring again to FIG. 1, FIG. 1 is a block flow diagram showing the operation of the image forming apparatus according to the first exemplary embodiment. Referring now to FIG. 15, FIG. 15 is a block diagram of the image forming apparatus having the functions shown in FIG. 1.

The image forming apparatus according to the first exemplary embodiment includes an image forming unit 1 and a unit 2 for controlling conditions for forming images or positions in which images are formed for individual areas with different attributes on a surface of a medium. The image forming apparatus further includes a unit 3 for setting addresses on a surface of the medium P and a unit 4 for detecting the attribute information of the surface of the medium P to obtain the attribute information. The image forming apparatus further includes a conveying unit 5 that includes, for example, a medium feeder and rollers, a medium positioning unit 6 used to, for example, set addresses, and a control unit (CPU) 7 for performing overall control of the image forming apparatus. The image forming apparatus is connected to an external computer 8.

The components of the image forming apparatus according to the first exemplary embodiment will now be described in detail. In the first exemplary embodiment, an inkjet printer will be described as an example.

### Unit for Obtaining Attribute Information of Individual Areas on Surface of Medium

In the image forming apparatus according to the first exemplary embodiment, addresses are set on a surface of a medium, and the attribute information is obtained using the unit 4 for detecting the attribute information of a surface of a medium.

The unit 3 for setting addresses on a surface of the medium P will now be described. The position of the origin point of a medium is determined using the conveying unit 5 and the medium positioning unit 6, and then addresses are set using the address setting unit 3. FIG. 5 shows the outline of addresses setting. In the first exemplary embodiment, the medium P is conveyed with the bottom of the medium P shown in FIG. 5 being the leading end. The medium positioning unit 6 puts the leading end of the medium P to be conveyed to a stopping member for determining the position of the leading end and further forwards the medium P slightly so as to adjust the orientation of the medium P so that the stopping member is parallel to a side of the medium P that is the leading end. A mechanism for alignment and positioning is provided. In this mechanism, an appropriate position of the medium P positioned appropriately is stored as the position of the origin point, and then addresses are appropriately set.

Next, the unit 4 for detecting the attribute information of a surface of a medium will be described. FIG. 2 shows an example of the unit 4 for detecting the attribute information of a surface of a medium. In the first exemplary embodiment, a medium sensor array (a unit for detecting the attributes of a surface of a medium) in which sensors that can detect the physical properties of a medium are arranged in an array is used.

A unit 101 for detecting the attribute information of a surface of a medium (hereinafter called a medium sensor array) includes elements each including an external-force applying unit 102, an external-force applying member 103, and an external-force detecting unit 104. The external-force applying member 103 and the external-force detecting unit 104 oppose each other, sandwiching the medium P. In this arrangement, n or more such sensors are arranged in a row in the x-axis direction of the medium P (a direction lateral to the y-axis that is the conveying direction) so that at least one element corresponds to an interval, shown in FIG. 5, at which a surface of a medium is divided.

The operation of the medium sensor array 101 according to the first exemplary embodiment will now be described. The external-force applying units 102 first apply an external force to the medium P in synchronization with conveyance of the medium P by a conveying unit (not shown) in the y-axis 106 direction. The properties of the intervening medium P, including the rigidity, are detected by detecting the applied external force via the medium P using the external-force detecting units 104.

The external-force applying units 102 apply an external force by moving the external-force applying members 103 in the vertical or z-axis 108 direction in FIG. 2, using a solenoid or a spring cam. The value of an external force is determined in a range in which the medium P is not damaged. The external-force detecting units 104 include pressure-sensitive elements (for example, piezoelectric elements, piezoresistive elements, or electrostatic pressure sensors). The external-force detecting units 104 may include depressions for deforming the medium P. In this case, an arrangement in which a medium is deformed by applying an external force, and the detected external force varies with the deformability of the medium is adopted. The medium sensor array 101 may include a drive mechanism for, for example, position adjustment and scanning in the x-axis direction and retraction and position adjustment in the z-axis direction.

Unit for Determining Conditions for Forming Images or Positions in which Images are Formed Corresponding to Attributes

In the present invention, image formation suitable for the different attributes of individual areas in a medium is performed. Thus, the unit 2 for determining conditions for forming images or positions in which images are formed determines conditions for forming images or positions in which images are formed corresponding to the attributes of individual areas. The unit 2 may control conditions for forming images and/or positions in which images are formed. The unit 2 determines whether to control either conditions for forming images or positions in which images are formed, or both.

The unit 2 for determining conditions for forming images or positions in which images are formed obtains address information from the address setting unit 3 and attribute information from the attribute-information detecting unit 4, and image data is input. Control of image formation is determined on the basis of these pieces of information, and the result of determination is output to the image forming unit 1. The unit 2 may also include a function of converting input image data to the operation of the image forming unit 1.

Unit for Forming Images with Conditions for Forming Images

The image forming unit 1 according to the first exemplary embodiment includes at least a function of performing image formation suitable for the different attributes of individual areas in a medium in response to signals from the unit 2 for determining conditions for forming images or positions in which images are formed.

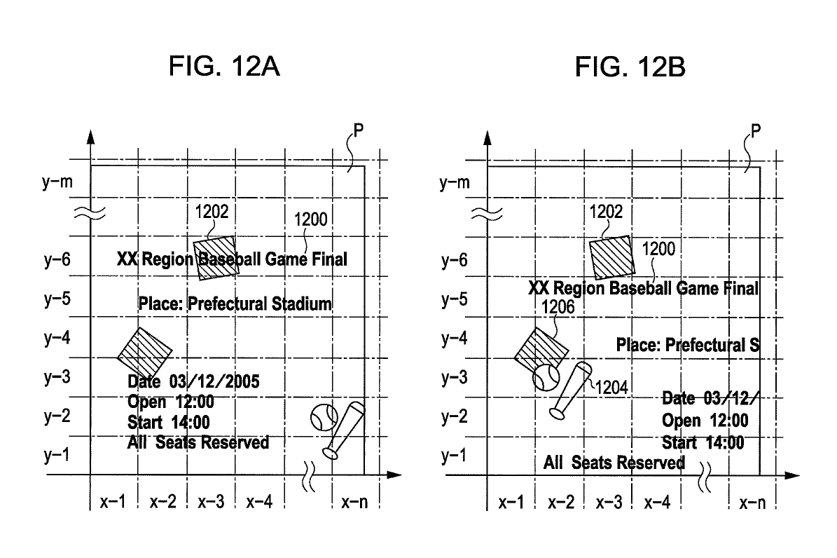

FIG. 14 shows an example of the image forming unit 1 according to the first exemplary embodiment. In the example shown in FIG. 14, an inkjet print head that includes a plurality of nozzles and can change the print mode so as to fit areas in the medium P is illustrated. The image forming unit 1 includes an inkjet print head 11 as a main component. The inkjet print head 11 ejects coloring material (ink) 12 in the form of droplets onto the medium P from the nozzles. FIG. 14 is a sectional view of an area y-3 in FIG. 12B, taken along a line parallel to the x-axis, showing a process of depositing coloring ink on a medium in the image forming process. In the process of depositing coloring ink on a medium, images with approximately even color density are formed. In this example, the amount of ink supplied to areas x-1 and x-2 is changed to be different from the amount of ink supplied to other areas. Changing the print mode so as to fit areas in a medium may include:

changing the amount of ink to be supplied,

changing the type of ink,

changing the balance among the amounts of individual ink colors to be ejected,

changing the number of times printing is repeated, and

changing the positions of dots to be printed.

The image forming unit 1 according to the first exemplary embodiment includes a function of changing positions in which images are formed on a medium. In this function, for example, in a manner that depends on the control information of positions in which images are formed, the ejecting nozzle is changed, or the position of the inkjet print head 11 relative to a medium is changed.

The image forming unit 1 forms important information in image data on areas in a medium most suitable for image formation in a manner that depends on the different attributes of areas in the medium. The image forming unit 1 may form a part of less important information in image data on areas not suitable for image formation. However, in this case, conditions for forming images are appropriately changed so as to fit the areas. In the first exemplary embodiment, an image forming apparatus can be provided, in which, even for a medium the attribute of which varies with areas on the medium surface, defects in images can be reduced, and high-definition images can be formed.

### Second Exemplary Embodiment

An exemplary image forming method in which the image forming apparatus according to the first exemplary embodiment is used will now be described as a second exemplary embodiment.

Referring again to FIG. 1, FIG. 1 is a block flow diagram showing the operation of the image forming apparatus in the second exemplary embodiment, and referring again to FIG. 15, FIG. 15 is a block diagram of the image forming apparatus.

In the second exemplary embodiment, a case will be described, in which images in which illustrations and characters are mixed are printed on a cut sheet as a medium in which an RFID that is a semiconductor element is embedded, using an inkjet printer. In the second exemplary embodiment, when images are formed in positions in which an RFID that is an embedded object in a cut sheet is embedded, the possibility that, for example, characters might blur needs to be considered. The same applies even in the case of embedded objects other than an RFID.

### Method for Obtaining Attribute Information of Individual Areas on Surface of Medium

In the image forming apparatus in the second exemplary embodiment, addresses are set on a surface of a medium, and the attribute information is obtained using the unit 4 for detecting the attribute information of a surface of a medium.

A method for setting addresses on a surface of the medium P will first be described. In FIG. 15, the position of the origin point of a medium is determined using the conveying unit 5 and the medium positioning unit 6, and then addresses are set using the address setting unit 3. The operations of the individual units are the same as those described in the first exemplary embodiment. FIG. 5 shows the outline of addresses setting. A side of the medium P that is the leading end is set as the x-axis, and a side of the medium P, orthogonal to the x-axis, passing through the position of the origin point is set as the y-axis. Moreover, the x-axis and the y-axis are divided at regular intervals, and x-1 to x-n and y-1 to y-m are assigned respectively. In the drawing, the values of n and m are less than actual numbers for the sake of simplification. In the second exemplary embodiment, the x-axis and the y-axis are divided at intervals of 1 mm. In the second exemplary embodiment, an address in a surface of a medium is shown in the form: (x-a, y-b), where a and b are integers.

Next, the unit 4 for detecting the attribute information of individual addresses on a surface of a medium will be described.

FIG. 2 shows the example of the unit for detecting attribute information. In the second exemplary embodiment, since the medium P subjected to detection is a cut sheet in which an RFID that is a semiconductor element is embedded, the rigidity of an area in which an RFID is embedded is different from those of other areas. Information (attribute) on a medium corresponding to individual addresses is obtained on the basis of information on the difference in the rigidity.

In the second exemplary embodiment, the medium sensor array 101 (the unit for detecting the attributes of a surface of a medium), in which sensors that can detect the physical properties of a medium are arranged in an array, is used. For example, in a case where the information of an address (x-1, y-3) is obtained, when the medium P is conveyed, so that the area y-3 of the medium P is located on the medium sensor array 101, a sensor located in the area x-1 is caused to operate to obtain the corresponding information of the medium P. In the drawing, a medium sensor element corresponds to an address in a medium. Alternatively, a plurality of medium sensor elements may correspond to an address, or a single medium sensor element may detect the attribute information of a plurality of addresses.

The medium sensor array 101 detects which address an RFID is embedded as information (attribute) on a medium corresponding to individual addresses. In the second exemplary embodiment, the information of an area that covers addresses (x-1, y-3), (x-2, y-3), (x-1, y-4), and (x-2, y-4) shown in FIG. 5 is obtained. Moreover, the information of an area substantially corresponding to an address (x-3, y-6) is obtained, so that the information of areas in which RFIDs are embedded is obtained. Moreover, the information of an area the rigidity of which is different from those of surrounding areas due to, for example, variations in manufacturing of the medium is obtained. These items of information are obtained regarding areas in the medium P on which images are formed.

Method for Determining Conditions for Forming Images or Positions in which Images are Formed Corresponding to Attributes

In the second exemplary embodiment, positions in which images are formed are determined so that important character information is formed on areas other than an area in which an RFID exists. Furthermore, input image data is readjusted so as to optimize conditions for forming images for an area in which an RFID exists.

FIGS. 12A and 12B show exemplary readjustment of image data to accommodate areas having different attributes. FIG. 12A shows an example in which original image information is overlaid on the medium P shown in FIG. 2. FIG. 12B shows an example in which images are formed after the positions of the images are readjusted.

When the original image information having not been readjusted is used, character information 1200 overlaps with the positions of RFIDs, such as an RFID 1202, as shown in FIG. 12A. Thus, problems such as blurring may occur, so that important information may become invisible.

Thus, the positions of images are readjusted so as to prevent character information and RFIDs from overlapping, as shown in FIG. 12B.

In the second exemplary embodiment, the positions of images are readjusted according to a process (1300) shown in FIG. 13. Image data that includes characters (important information in the second exemplary embodiment) and illustrations (less important information in the second exemplary embodiment) and the address information and attribute information of a medium are first input (1302). Using the input medium information, it is determined whether there are any addresses at which it is difficult to form an image (1304). If there are no such areas, images are formed on the medium after adjusting for conditions (1306).

If there are addresses at which it is difficult to form images, the process determines if any of the problem areas can be avoided by a parallel shift of all images (1308). If so, the images are formed on the medium after adjusting positions and conditions (1310).

If the problem areas cannot be avoided by a parallel shift of all images, the process next determines if problem areas in the medium can be avoided by a shift of some of the images (1312). If so, the images are formed after adjusting the positions of some of the images and conditions (1314).

If merely shifting some or all of the images does not result in the problem areas being avoided, the process next determines if the problem areas can be avoided by a position shift and reduction of some of the images (1316). If so, the images are formed after adjusting positions and conditions (1318). If the problem areas cannot be avoided by a position shift and reduction of some of the images, the medium or paper is ejected without forming any images (1320).

In regard to characters, in order to avoid first addresses at which it is difficult to form images, the positions of the characters are adjusted to the extent that the positions of the characters are not vertically swapped, and the font sizes of the characters are reduced to the extent that visibility is not impaired. In regard to illustrations, since the level of importance is low, the illustrations are allowed to overlap with the first addresses. The permissible range of, for example, movement or reduction, associated limitations, and the like are separately defined. Finally, when predetermined conditions are not satisfied, the medium is ejected without no image being formed thereon, or is stocked to form other images thereon.

Moreover, for example, and referring again to FIG. 12B, an illustration 1204 overlaps with an embedded object 1206 at the address (x-2, y-3). Since the effective thickness of paper is small at the address (x-2, y-3), the amount of ink to be ejected is determined in a mode suitable for thin paper. For areas other than the address (x-2, y-3), the amount of ink to be ejected is determined in a mode suitable for the individual areas. Furthermore, additional adjustment is performed, considering how much penetrating ink is blocked by an embedded object. In the case of color images, the balance among the colors is also adjusted.

### Method for Forming Images Using Image Forming Unit

Images are formed on a recording medium with conditions for forming images determined in the aforementioned manner. Since the aforementioned attribute information varies with individual media, image formation that is correspondingly controlled is performed. Even when images are formed on a plurality of media, loss of character information can be eliminated, and high-definition image information can be formed.

In the second exemplary embodiment, when it is determined that difficulty or a trouble in image formation occurs at a certain address, an adjustment is performed so that images are formed in appropriate shapes in appropriate positions, avoiding the address. Thus, the image of important information can be appropriately formed.

### Third Exemplary Embodiment

In a third exemplary embodiment, the image forming apparatus according to the present invention and the image forming method, in which the image forming apparatus is used, will be described, referring to an electrophotographic apparatus as an example.

In the third exemplary embodiment, an example will be described, in which, in a case where paper is used as media, and the distribution of water content (an attribute) on a surface is wide, conditions for forming images are appropriately controlled. Ordinary copy sheets that are stacked and packed in a hermetically sealed package are used as media used in the description of the third exemplary embodiment. After such media are unpacked, the media take up moisture at parts in direct contact with the ambient atmosphere. Thus, in many cases, the media take up moisture at the outer edges thereof and become deteriorated. Accordingly, the following arrangement is adopted, considering that attributes, including water content, rigidity, and electrical resistance, change along a direction from the contour of media to the center.

Referring again to FIG. 1, FIG. 1 is a block flow diagram showing the operation of the image forming apparatus in the third exemplary embodiment. Referring again to FIG. 15, FIG. 15 is a block diagram of the image forming apparatus. The structure of the image forming apparatus in the third exemplary embodiment is similar to that in the first exemplary embodiment. In the third exemplary embodiment, the image forming apparatus will be described, referring to an electrophotographic apparatus that functions as an image forming unit and transfers toner as coloring material to a medium and fixes the transferred toner as an example.

### Obtaining Attribute Information of Individual Areas on Surface of Medium

In the third exemplary embodiment, units and methods for setting addresses on a surface of a medium and detecting the attribute information of the surface of the medium will be described.

A unit according to the third exemplary embodiment for setting addresses on a surface of the medium P is similar to that according to the first exemplary embodiment. A method according to the third exemplary embodiment for determining the position of the origin point is similar to that according to the second exemplary embodiment. However, in the third exemplary embodiment, the contour of a medium is set as the datum, and addresses are determined by distances from the datum as shown in FIG. 8.

Next, the unit 4 for detecting the attribute information of a surface of a medium will be described. FIG. 17 shows an exemplary unit for detecting attribute information used in the third exemplary embodiment. In the third exemplary embodiment, a unit 141 for detecting the attribute information of a surface of a medium (hereinafter called a medium sensor array) includes a detecting unit 144. In this arrangement, n or more elements are arranged in a row in the x-axis direction of the medium P (a direction lateral to the y-axis that is the conveying direction) so that at least one element corresponds to an interval, shown in FIG. 5, at which a surface of a medium is divided. The detecting unit 144 obtains information related to the water content of a medium. In the third exemplary embodiment, a protector for avoiding contact with a medium is provided in a high-speed humidity detection element, and the information of the humidity in the neighborhood of a medium is obtained using the high-speed humidity detection element.

The operation of the medium sensor array 141 will be described as a method for obtaining attribute information in the third exemplary embodiment. The information of the water content of a medium is obtained, using the detecting unit 144, in synchronization with conveyance of the medium P by a conveying unit (not shown) in the y-axis direction. The medium sensor array 141 may include a drive mechanism for, for example, position adjustment and scanning in the x-axis direction and retraction and position adjustment in the z-axis direction.

In the media used in the image formation in the third exemplary embodiment, considering that the attribute changes along a direction from the contour of media to the center, the contour of media is set as the datum, and addresses are determined by distances from the datum, as described above. Addresses are represented as xy-1, xy-2, . . . , xy-n corresponding to distances. The attribute of each address area is processed as an average value. In the third exemplary embodiment, for example, a case where media packed in a package are unpacked and left for while in a relatively humid environment will be described. In such a case, since stacked media are exposed to a relatively humid environment, the media take up moisture at the upper surface and outer edges of the top medium. That is to say, when image formation is started with the top medium, the water content is highest in the first medium, decreases gradually in a definite number of media following the first medium, and is approximately constant in the remaining media. Moreover, on a surface of a medium, the water content is highest at the address xy-1 close to the contour, decreases gradually as the distance from the contour increases, and is lowest at the address xy-n. Such information is obtained regarding areas in the medium P on which images are formed.

Determining Conditions for Forming Images or Positions in which Images are Formed Corresponding to Attributes

In the third exemplary embodiment, the conditions for forming images of the electrophotographic apparatus are controlled so as to be appropriate values corresponding to the different attributes of individual areas in a medium. Specifically, units and methods for controlling conditions for fixing toner in a manner that depends on areas in a medium will now be described.

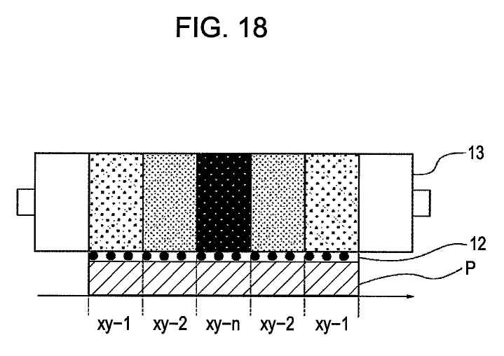

In the image forming apparatus in the third exemplary embodiment, an arrangement is adopted, in which an image forming unit fixes toner separately on divided areas on a surface of a medium, and conditions for fixing toner can be changed separately for the individual areas on the surface of the medium. FIG. 18 shows the outline of the process of fixing toner in a fixing unit. A fixing unit 13 that functions as a part of an image forming unit fixes coloring material (toner) 12 having been transferred to the medium P by heating. The fixing unit 13 includes separate heaters corresponding to individual addresses on a surface of a medium and can change conditions for heating. Moreover, a driver (not shown) that drives the fixing unit 13 can control electrical power input to each of the separate heaters. In the third exemplary embodiment, conditions for forming images are determined so as to achieve optimal conditions for heating corresponding to the water content of the individual addresses xy-l to xy-n in a medium.

In the third exemplary embodiment, conditions for transferring coloring material (toner) to a medium can be controlled in a manner that depends on individual addresses as other exemplary conditions for forming images.

### Method for Forming Images Using Image Forming Unit

Images are formed on a medium with conditions for forming images determined in the aforementioned manner. Since the aforementioned attribute information varies with individual media, image formation that is correspondingly controlled is performed.

In the third exemplary embodiment, since fixing conditions are controlled in a manner that depends on the water content of individual addresses on a surface of a medium, defects in images can be reduced, and the curling of a medium can be suppressed.

### Fourth Exemplary Embodiment

In a fourth exemplary embodiment, the present invention can also be applied to a case where, after images are formed on the front surface of a medium as in the third exemplary embodiment, images are formed on the back surface of the medium (what is called two-sided copying).

For example, when images are formed on the front surface of a medium, heating for, for example, fixing causes a change in the water content, a change in the size due to expansion and contraction, and deformation such as curling on each area in the medium. Such information is detected by a unit according to the present invention so as to control, for example, positions in which images are formed or conditions for forming images so as to be appropriate values corresponding to the different attributes of areas in a medium. Images are formed under such control.

In the fourth exemplary embodiment, even when two-sided copying is performed, for example, adjustment of the shift of positions of images and color matching can be readily performed.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-092030 filed Mar. 30, 2007, which is hereby incorporated by reference herein in its entirety.

What is claimed is:

1. An image forming apparatus comprising:
an image forming unit configured to form images on a surface of a medium having a plurality of areas with different attributes, the images formed on the basis of input image information; and
a determination unit configured to determine, for the plurality of areas, conditions for forming images or positions in which images are formed,
wherein the image forming unit forms images on the basis of conditions for forming images or positions in which images are formed determined by the determination unit.

2. The image forming apparatus according to claim 1, further comprising:
an address setting unit configured to set addresses on the surface on which images are to be formed; and
an attribute-information detecting unit configured to detect attribute information that indicates the attributes of the plurality of areas,
wherein the conditions for forming images or the positions in which images are formed are determined on the basis of the addresses set by the address setting unit and information of the attributes detected by the attribute-information detecting unit.

3. The image forming apparatus according to claim 2, wherein the attribute-information detecting unit includes an external-force applying unit configured to apply an external force to the medium for forming images; an external-force detecting unit configured to detect, via a medium, an external force applied by the external-force applying unit; and
an attribute-information obtaining unit configured to obtain the information of the attributes on the basis of the result of detection by the external-force detecting unit.

4. The image forming apparatus according to claim 1, wherein controlling the conditions for forming images includes controlling positioning of images.

5. The image forming apparatus according to claim 1, wherein controlling the conditions for forming images includes controlling at least one of conditions for transferring coloring material, the amount of coloring material to be transferred, or conditions for fixing coloring material.

6. An image forming method comprising:
forming images on a surface of a medium having a plurality of areas with different attributes, the images formed on the basis of input image information;
determining, for the plurality of areas, conditions for forming images or positions in which images are formed; and
forming images on the basis of determined conditions for forming images or positions in which images are formed.
